(19) United States
(12) Patent Application Publication
(10) Pub. No.: US 2015/0043608 A1
(43) Pub. Date: Feb. 12, 2015

(54) Soderberg Electrode Case Design

(71) Applicant: Dow Corning Corporation, Midland, MI (US)

(72) Inventors: Roger Bartlett, Pewee Valley, KY (US); Agustin Fernandez, Wetumpka, AL (US); Christopher Kozenski, La Grange, KY (US); Danny Ward, Crestwood, KY (US)

(73) Assignee: Dow Corning Corporation, Midland, MI (US)

(21) Appl. No.: 14/386,360

(22) PCT Filed: Apr. 8, 2013
(86) PCT No.: PCT/US13/35580

§ 371 Date: Sep. 19, 2014

Related U.S. Application Data
(60) Provisional application No. 61/622,567, filed on Apr. 11, 2012.

(51) Int. Cl. H05B 7/09

(52) U.S. Cl. CPC H05B 7/09
USPC 373/89

(57) ABSTRACT

An electrode case used to make a self-baking electrode that is consumed in a reducing arc furnace and the electrode made therefrom is described. The electrode case comprises an outer sleeve and a plurality of fins. The outer sleeve is divided into multiple sleeve sections made from a first metal, such that each sleeve section has an outer and inner surface, the multiple sleeve sections capable of being stacked together to form the outer sleeve. The plurality of fins is divided into multiple fin sections made from a second metal, such that each fin section is mechanically coupled to the inner surface of one sleeve section along its length and project radially therefrom along its width. Each fin section has an upper interface region, a central support region, and a lower interface region; the upper, central, and lower support regions having a lattice structure with at least 10% open area. Each fin section exhibits a constant volume of the second metal per unit length with the upper interface region of one fin section being capable of overlapping with the bottom interface region of another fin section.

This disclosure relates generally to a self-baking electrode for use in a reduction furnace. More specifically, this disclosure relates to the design of an electrode case used to form a self-baking electrode, as well as a method of making a self-baking electrode therefrom.

Soderberg electrode technology is widely used in submerged arc furnaces. This technology uses the heat from current flowing through the electrode to bake additional electrode material that can be fed into the furnace to replace the electrode length that has been lost during normal furnace operation. The technology uses an outer metal case with an inner metal support structure to contain the raw materials used to form the electrode, provide a shape to bake the materials as the electrode, and provide the necessary structural support. During operation, sections of the metal case and internal support structure are continually stacked on top of each other in order to allow the consumable electrode to be continuously formed. Soderberg electrode technology has advantages of cost and reliability over previously used methods that include (i) adding sections of preformed, pre-baked electrodes on to the top of the electrode being consumed or (ii) replacing the entire electrode that has burnt away with a new electrode.

The Soderberg electrode technology does, however, have limitations when used in different industries. For example, when this technology is used in the manufacturing of chemical grade silicon, limitations exist due to the stringent low iron and other impurity levels required in the final product produced. As a result, metal cases and a support structure comprised of standard carbon steel cannot be used in this industry. For the production of silicon, the outer metal case and inner support structure has to be made from another metal. Typically, either stainless steel or aluminum is selected for use as the metal case with stainless steel being used to make the inner support structure due to its strength. Although the use of stainless steel and/or aluminum in the case and support structure makes the Soderberg technology feasible for this application, many problems still exist. Due to the high purity requirements associated with the silicon product, the metal support structure must be minimized which results in a design that is not robust and always in danger of breaking or collapsing. In addition, in order to enhance structural support, this design requires that the inner structure of each case section added to the stack is welded to the internal structure of the previous case in the stack. The welding of stainless steel introduces potential issues of worker exposure to hexavalent chromium compounds formed during the welding process.

### BRIEF SUMMARY OF THE INVENTION

In overcoming the enumerated drawbacks and other limitations of the related art, the present invention provides an electrode case used to make a self-baking electrode that is consumed in a reduction-type furnace, the electrode prepared therefrom, and a method of preparing the same.

According to one aspect of the present disclosure, the self-baking electrode comprises an outer sleeve, a plurality of fins, and an electrode paste confined within the outer sleeve and in contact with the plurality of fins. The outer sleeve is divided into multiple sleeve sections made from a first metal, such that each sleeve section has an outer and inner surface. The multiple sleeve sections are capable of being stacked together such that they form the outer sleeve. Optionally, at least one of the multiple sleeve sections may be coupled to another sleeve section by either a weld or a slip joint.

The fins are divided into multiple fin sections made from a second metal, such that each fin section is mechanically coupled to the inner surface of one sleeve section. Each fin section is further defined by an upper interface region, a central support region, and a lower interface region. The upper interface region, central support region, and lower interface region have a lattice structure with at least 10% open area, alternatively with greater than 30% open area, distributed such that each fin section exhibits a constant volume of the second metal per unit length. The upper interface region of one fin section is capable of being overlapped with the bottom interface region of another fin section.

According to another aspect of the present disclosure, the first metal and second metal are independently selected as one from the group of aluminum, carbon steel, stainless steel, and copper. Alternatively, the first metal and the second metal are different metals.

Each sleeve section comprises between 2 and 25 fin sections, which along their length may be either straight or bent in shape. Each fin section may project from the inner surface of the sleeve section at a predetermined angle α, alternatively, the fin section may project radially from the sleeve section along its width. The central support region and optionally the upper and lower interface regions of each fin section may further comprise first and second side bars of a predetermined width and length located along the longitudinal edge of the fin section. The first side bar contacts the inner surface of the sleeve section and is fastened thereto. The first and second side bars may be either similar in width or one of the side bars can be wider than the other. The length and width of the side bars may be predetermined based on the amount of structural support or integrity one skilled in the art desires the lattice structure to provide.

The amount of overlap between the lower interface region of one fin section and the upper interface region of another fin section is predetermined to provide a degree of structural integrity to the electrode such that the fin sections do not need to be fastened together. Alternatively, the lower interface region of one fin section and the upper interface region of another fin section are fastened together. When desirable, the fin sections are mechanically fastened together through the use of rivets, bolts, pins, or screws.

According to another aspect of the present disclosure, an electrode case used to make a self-baking electrode that is consumed in a reducing arc furnace comprises the outer sleeve and plurality of fins as described above and further defined herein. The amount of open area in the plurality of fins is greater than or equal to 0.0042 cm² per vertical centimeter of case per kilogram of electrode to be supported.

According to yet another aspect of the present disclosure, the electrode case may comprise an outer sleeve divided into multiple sleeve sections made of a first metal and a plurality of fins divided into multiple fin sections made of a second metal with each fin section being a solid bar or cylinder such that each fin section exhibits a constant volume of the second metal per unit length. The first metal in each sleeve section and the second metal in each fin section are independently selected as one from the group of aluminum, carbon steel, stainless steel, and copper.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic representation of a self-baking electrode as used in a reduction furnace;

FIG. 2a is a cross-sectional view of the self-baking electrode of FIG. 1 prepared according to the teachings of the present disclosure at the union of two sections of cases;

FIG. 2b is a cross-sectional view of a sleeve section used in the self-baking electrode of FIG. 1 showing an alternative arrangement for the fin sections in the sleeve section;

FIG. 2c is a cross-sectional view of a sleeve section used in the self-baking electrode of FIG. 1 showing another alternative arrangement for the fin sections in the sleeve section;

FIG. 2d is a cross-sectional view of a sleeve section used in the self-baking electrode of FIG. 1 showing yet another alternative arrangement for the fin sections in the sleeve section;

FIG. 2e is a cross-sectional view of a sleeve section used in the self-baking electrode of FIG. 1 showing yet another alternative arrangement for the fin sections in the sleeve section;

FIG. 3 is a schematic representation of the overlap between the upper interface region of a first fin section with the lower interface region of a second fin section as used in the self-baking electrode of FIG. 2;

FIG. 4 (A-I) are schematic representations of various geometries of the lattice structure associated with the fin sections used in the electrode casing according to different aspects of the present disclosure;

FIG. 5 (A-B) are schematic representations of the shape of the fins prepared according to the teachings of the present disclosure; and

FIG. 6 (A-B) are schematic representations of the coupling of the fin section to the outer sleeve used in the electrode case according to different aspects of the present disclosure.

### DETAILED DESCRIPTION

The following description is merely exemplary in nature and is in no way intended to limit the present disclosure or its application or uses. It should be understood that throughout the description, corresponding reference numerals indicate like or corresponding parts and features.

The present disclosure generally relates to an electrode case or sleeve used to make a self-baking electrode that is consumed in a reduction furnace, as well as the electrode prepared using such a sleeve and a method of preparing the same. The electrode case or sleeve made and used according to the teachings contained herein is described throughout the present disclosure in conjunction with the manufacturing of silicon and silicon alloys in order to more fully illustrate the concept. The incorporation and use of such an electrode sleeve in conjunction with other types of reduction furnaces, including but not limited to submerged arc furnaces and electric smelters that can produce iron metal, ferroalloys, non-ferrous metals, and CaC₂, among others, is contemplated to be within the scope of the disclosure.

The following specific embodiments are given to illustrate the design and use of an electrode case according to the teachings of the present disclosure and should not be construed to limit the scope of the disclosure. Those skilled-in-the-art, in light of the present disclosure, will appreciate that many changes can be made in the specific embodiments which are disclosed herein and still obtain a like or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

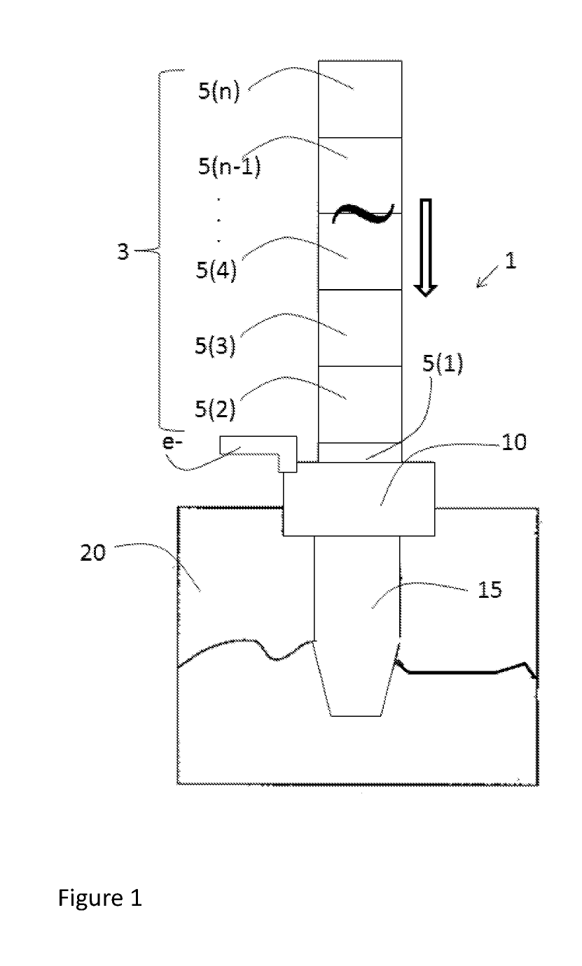

Referring to FIG. 1, a self-baking electrode 1 used in a reduction-type furnace 20 is provided. This self-baking electrode 1 is generally comprised of an electrode case 3 that is divided into n multiple sleeve sections 5(1→n) that are vertically stacked one top of another. As the portion of the electrode 15 in the furnace 20 is consumed, the sleeve sections 5(1→n) continually move downward. This downward movement allows for a new electrode sleeve section 5(n) to be constructed and placed on top of the stack. The new electrode sleeve section 5(n) may be secured to the sleeve section 5(n−1) beneath it through the fastening of the sleeve sections together. The number of electrode sleeve sections, 5(1)→5(n), stacked together may be any desirable height, even if the top of the electrode case 3 is located proximate to the ceiling of the building in which the furnace is constructed. During operation, the first electrode sleeve section 5(1) is subjected to a thermal zone 10 heated by the application of power, such as electricity, in which the temperature is high enough to cause the sleeve section 5(1) to melt and the carbon paste contained within that sleeve section to bake, thereby, forming the electrode 15. The self-baked electrode 15 prepared in this manner is subsequently consumed within the furnace 20 when used in the production of silicon alloys or other materials.

According to one aspect of the present disclosure, the use of sleeve sections 5 for “Soderberg” paste electrodes 1, in which steel is partially or entirely replaced with aluminum is desirable for the production of silicon alloys. Although aluminum is an element that is usually also included in a silicon alloy, unlike steel, it can be virtually eliminated in subsequent refining operations in which calcium and aluminum oxides are removed as slag. The use of aluminum in the manufacture of sleeve sections 5 imposes more demanding operating conditions in order to compensate for its lower mechanical strength and low melting point. In other words, during operation the elongation of the electrodes must be done in the most continuous way possible and the position of the isotherms in the paste-baking region must be controlled. Alternatively, stainless steel sleeve sections may also be used in the production of silicon alloys; provided the thickness of the sleeve sections 5 is reduced in order to limit the amount of iron that the sleeve section 5 contributes to the silicon alloy.

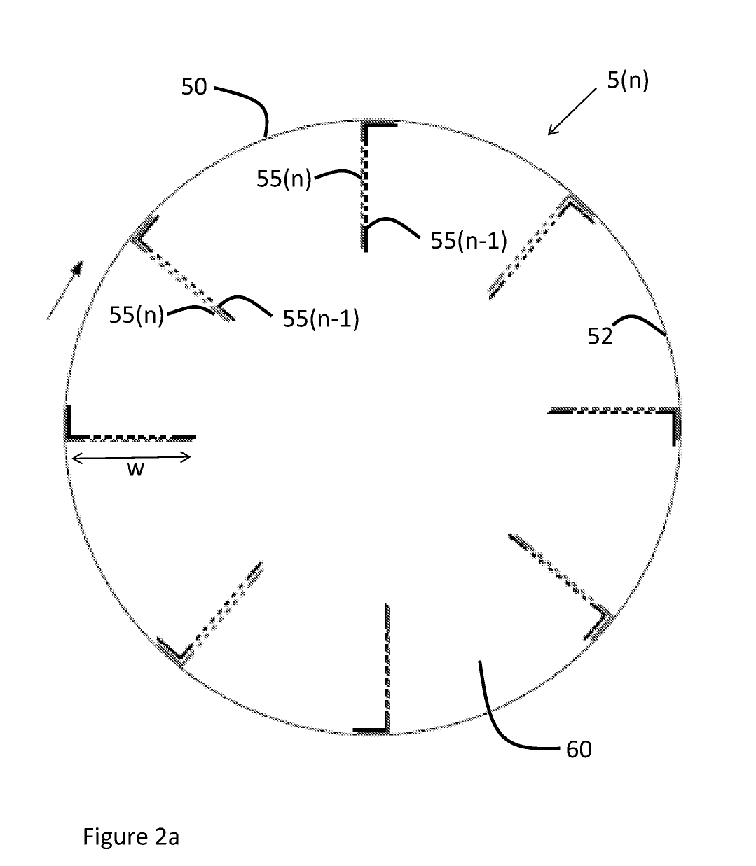

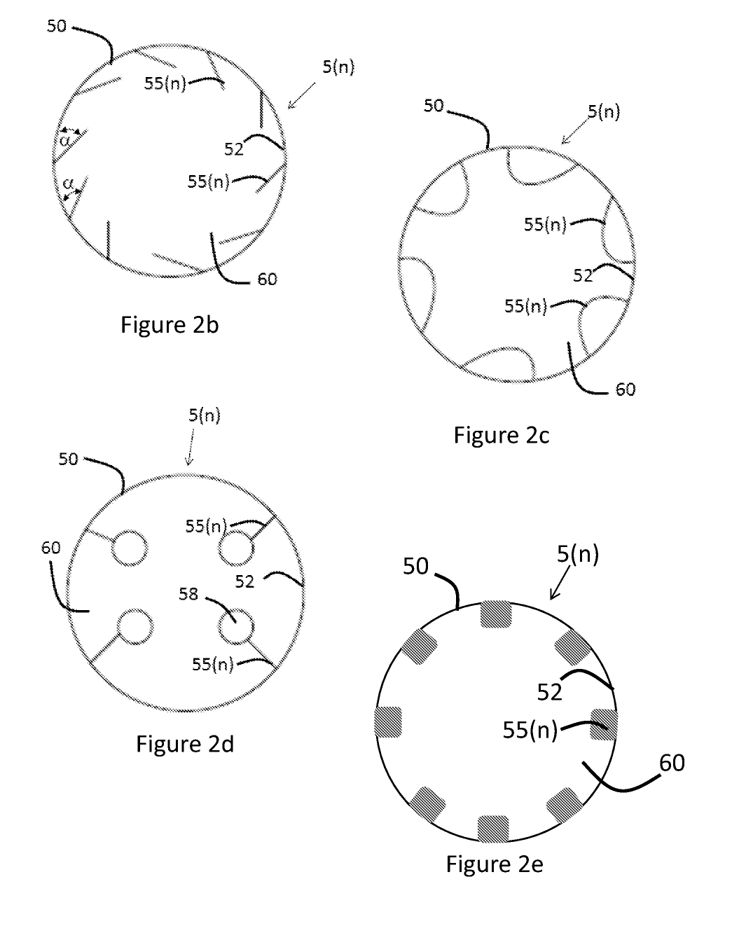

Referring now to FIG. 2a, each electrode sleeve section 5(n) comprises an outer sleeve 50 having an inner surface 52 and outer surface made of an electrically conductive material with multiple fin sections 55 being vertically attached to the inner surface 52 of the outer sleeve 50. The outer sleeve 50 for each electrode sleeve section 5(n) is open at both ends. The geometry of the outer sleeves 50 is predetermined during the construction of the furnace and may be any desirable shape, including circular or cylindrical, as well as square, among others. The stack of multiple electrode sleeve sections 5(1→n) forms a container in which an electrode paste 60 is initially added in a raw unbaked form and allowed to make contact with both the inner surface 52 of the outer sleeve 50 and the fin sections 55. With the passage of electric current through the paste, it is baked and formed into a solid electrode 15. The fin sections 55(n) associated with one sleeve section 5(n) may be slightly off-set from the fin section 55(n−1) associated with an adjoining sleeve section 5(n−1), such that the fin sections 55 are allowed to overlap. Still referring to FIG. 2, each fin section 55 located in a sleeve section 5 is mechanically coupled to the inner surface of the outer sleeve 50 along its length and projects radially therefrom along its width (w).

Referring now to FIGS. 2b-2e, alternative arrangements for the fin sections 55(n) in a sleeve section 5(n) are described. Similar to FIG. 2a, the electrode sleeve section 5(n) comprises an outer sleeve 50 having an inner surface 52 and outer surface made of an electrically conductive material with multiple fin sections 55 being vertically attached to the inner surface 52 of the outer sleeve 50. The outer sleeve 50 for each electrode sleeve section 5(n) is open at both ends. In FIG. 2b, each fin section 55 does not project radially from the inner surface 52 of the outer sleeve 50, but rather projects at a predetermined angle α. The predetermined angle α associated with each fin section 55 is independently selected to be within the range of about 10° to about 170°; alternatively between about 20° to about 150°. In FIG. 2c, another geometric configuration for the fin section 55 is shown in which at least two edges of the fin section 55 are vertically attached to the inner surface 52 of the outer sleeve 50. In FIG. 2d, yet another geometric configuration for the fin section 55 is shown wherein one edge of the fin section 55 comprises a loop 58. Finally, in FIG. 2e, another geometric configuration for the fin section 55 is shown wherein the fin section 55 is a solid bar or cylinder.

According to one aspect of the present disclosure, the outer sleeve 50 of each sleeve section 5(n) may be made from a first metal, while the plurality of fin sections 55 are made from a second metal. Alternatively, the first metal and second metal are the same metal. The first metal in each sleeve section 5(n) and the second metal in each fin section 55 may be independently selected as one from the group of aluminum, carbon steel, stainless steel, and copper. Alternatively, the first metal and the second metal are selected to be different metals. Alternatively, the first metal is aluminum and the second metal is stainless steel. The stainless steel and aluminum may include any known grade or related alloy, such as 304 stainless or aluminum 5052-H32 (an aluminum-magnesium alloy).

The number of fin sections 55 located in each outer sleeve 50 is independently selected depending upon the level or magnitude of the mechanical properties desired to support the weight or stress induced by the baked electrode 15. Alternatively, the number of fin sections 55 is selected to be between 2 and 25, alternatively between 4 and 19. In FIG. 2a, the outer sleeve 50 is shown as a specific example to incorporate eight fin sections 55. In FIGS. 2b, 2c, 2d, and 2e an example of an outer sleeve 50 with 10, 6, 4, and 8 fin sections 55 are described, respectively.

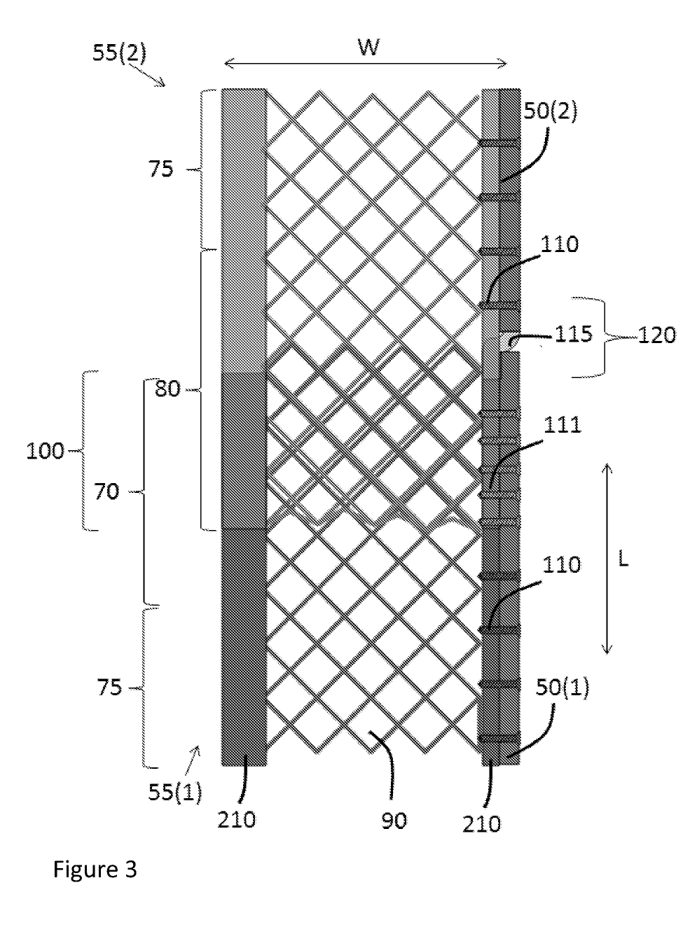

Referring now to FIG. 3, according to one aspect of the present disclosure each fin section 55 comprises an upper interface region 70, a central support region 75, and a lower interface region 80. The upper interface, central support, and lower interface regions 70, 75, 80 include a lattice structure 90 with at least 10% open area, alternatively greater than about 30% open area, alternatively, less than about 99.2% open area. The lattice structure is symmetrically designed such that each fin section 55 exhibits a constant volume of the second metal per unit length (L). The upper interface region 70 of one fin section 55(1) is capable of being overlapped 100 with the lower interface region 80 of another fin section 55(2). The lower interface 80 region of one fin section 55(2) generally extends beyond the end of the corresponding outer sleeve 50(2) in order to allow for the overlap 100 with the upper section 70 of a fin section 55(1) in a second outer sleeve 50(1). Alternatively, the upper interface region 70 of one fin section 55(1) may extend beyond the end of the corresponding outer sleeve 50(1) in order to allow for the overlap 100 with the lower section 80 of a fin section 55(2) in a second outer sleeve 50(2). The overlap of the fins sections 55(1,2) may assist in providing the strength necessary to support the additional weight being added to the electrode case via the outer sleeve 50(2), fin section 55(2) and electrode. The extent that the lower interface 80 region or the upper interface region 70 extends beyond the end of the outer sleeve 50 may vary; alternatively, the lower interface 80 or upper interface 70 region extends beyond the end of the outer sleeve 50 by about 20 mm or more, alternatively, between about 20 mm and about one-half the height of the outer sleeve 50, alternatively less than about one-half the height of the outer sleeve 50. The amount of open area in the lattice structure is more than 0.0025 cm²/vertical centimeter of the fin section per kilogram of electrode to be supported; alternatively more than 0.0032 cm²/vertical centimeter of the fin section per kilogram of electrode to be supported; alternatively greater than or equal to 0.0042 cm²/vertical centimeter of the fin section per kilogram of electrode to be supported.

According to another aspect of the present disclosure, one skilled in the art will understand that although the fin sections 55 are described in the context of an open lattice, the use of a fin section 55 that is a solid or hollow cylinder or bar can be utilized without exceeding the scope of the present disclosure. An example of such a fin section 55 is provided in FIG. 2e. Similar to FIG. 3, a fin section 55(1) comprised of a solid or hollow cylinder or bar may also include an upper interface region 70 that is capable of being overlapped 100 with the lower interface section 80 of another fin section 55(2). The cylinder or bar is designed such that each fin section 55 exhibits a constant volume of the second metal per unit length (L).

Still referring to FIG. 3, each fin section 55(1, 2) is secured directly to the inner surface of the corresponding outer sleeve 50(1, 2) through the use of fasteners 110 or welded thereto. Such fasteners 110 may include, but not be limited to, rivets, bolts, pins, or screws. Optionally, the inner fins can be attached to the outer shell indirectly via the use of brackets or the like, with fastening methods between the fins and the brackets and between the brackets and the outer shell using similar methods as described above or otherwise known to one skilled in the art.

The overlap 100 of the bottom interface 80 region of one fin section 55(2) with the upper 70 region of another fin section 55(1) may also be secured to the outer sleeve section 50 through the use of such fasteners 111. However, one skilled in the art will understand that the overlap 100 need not be physically connected together nor connected to the outer shell. In the specific example shown in FIG. 3, the overlap 100 is physically connected together and fastened to the outer shell, thereby, providing additional mechanical continuity. However, when having the overlap 100 physically connected is desirable: the method of fastening the overlapping fins together may be made in such a manner as to provide a joint that is under tension. The outer surface of the outer sleeve sections 50 may include notches, creases, or other structures as determined necessary or desirable.

The use of fasteners 110 to secure each fin section 55 to the inner surface of the corresponding outer sleeve 50 eliminates the need to weld the fin section 55 to the outer sleeve 50. Eliminating the need to weld the fin section 55 to the outer sleeve section 50 can lead to a reduction in manufacturing cost(s), as well as a reduction in potential worker exposure to hazardous conditions. For example, when the fin section 55 is comprised of stainless steel, the use of fasteners eliminates the need to weld the fin section 55 to the outer sleeve section 50, thereby, eliminating the potential exposure of workers to hexavalent chromium compounds formed during the welding process.

The outer sleeves 50 may be welded together in order to provide a leak-free joint. Such welding of the outer sleeves can be aided by the use of a backing plate or ring (not shown) placed around the outer surface of outer sleeves 50 such that it is located proximate to the point of contact between two sleeve sections. A leak-free joint 120 may also be accomplished by heating one of the outer sleeves 50, thereby, causing the metal to expand and placing the edge of the heated outer sleeve over the edge of another outer sleeve that has not been heated. Upon the cooling of the heated outer sleeve, the contraction of the metal in that sleeve against the metal surface in the other outer sleeve will result in the formation of a leak-free seal or a slip joint 120. Still referring to FIG. 3, such a leak-free seal or slip joint 120 is shown. In this specific case, the outer sleeve 50(1) is heated to a temperature between about 100° C. to about 250° C., alternatively, between about 100° C. to about 150° C., to cause the metal within the sleeve to expand. The edge of the second outer sleeve 50(2) is then placed into the first outer sleeve 50(1) such that the lower edge 115 of second outer sleeve 50(2) contacts the inner surface of the first outer sleeve 50(1). Upon cooling a leak-free compression seal 120 is formed between the outer sleeves 50(1, 2). Alternatively, cooling or a combination of heating and cooling can be used to accomplish the temperature differential required between the two outer sleeves sufficient enough to cause the change in diameters needed to slide one outer sleeve into the other.

Fin sections 55 that are comprised of stainless steel may be selected for the production of silicon alloys in which low iron content is desirable. In addition to having a low iron content, stainless steel is also selected due to its mechanical strength, i.e., its tensile strength at elevated temperatures, being capable of withstanding the weight and stress induced by the electrode column. Typically, silicon alloys having iron content less than about 0.35 wt. % can be produced. The dimensions associated with each fin section 55 are predetermined such that the fin section 55 provides the necessary mechanical support for the electrode column. The use of stainless steel fin sections 55 also allows for a light material, such as aluminum, to be used in the construction of the outer sleeve 50.

A constant volume of metal per unit area length of each fin section 55, as used herein, refers to amount of metal present in any longitudinal cross-sectional plane that intersects the width of the fin section 55 being about the same or constant. The amount of metal in each longitudinal cross-sectional plane can affect the structural strength of the electrode. The fin sections 55 used in the present disclosure maintain a symmetrical design, such that the cross-sectional area of metal in the fin section 55 is constant, or nearly constant, throughout the entire length of the fin section 55. This can be accomplished by the type of pattern or geometry associated with the lattice structure and holes. More specifically, these patterns include lattices, as well as perforated plates, grating patterns, and other expanded metal patterns. One skilled in the art will understand that the lattice structure is not limited to flat sheet pattern designs. Rather, the lattice structure can also be embodied by rod, tube, or cylindrical structural designs with no limitation to the type of rod or tube used. The desirability of selecting any given lattice structure for use in the fin section 55 of the present disclosure is determined by the consistency of the total cross sectional area of the structure in the vertical plane and the percent effectiveness of the metal used.

The amount of open area in the lattice structure allows the un-baked carbon paste to be integrated with the lattice support structure. In other words, the carbon paste occupies the open area in the lattice structure and assists in anchoring the metal in the fin section 55 in the electrode upon baking, thereby, providing an internal support structure for the electrode. The effectiveness of the fin design can be measured by the ratio of the minimum remaining cross-sectional area and the average remaining cross-sectional area. In conventional fin designs, the effectiveness of each design is typically in the range of 30-50% effective. In comparison, the design for the structure associated with the fins in the present disclosure increases the efficiency of the metal used to near 100%, absent any inefficiency intentionally introduced by overlapping the fin sections. The increased efficiency in the design allows the overlap in the fin sections to achieve the same overall fin metal efficiency required by the stringent purity requirements for the final product of the smelting operation. The overlap of fin sections eliminates the need to weld the stainless steel and eliminates the potential for employees to be exposed to hexavalent chromium compounds.

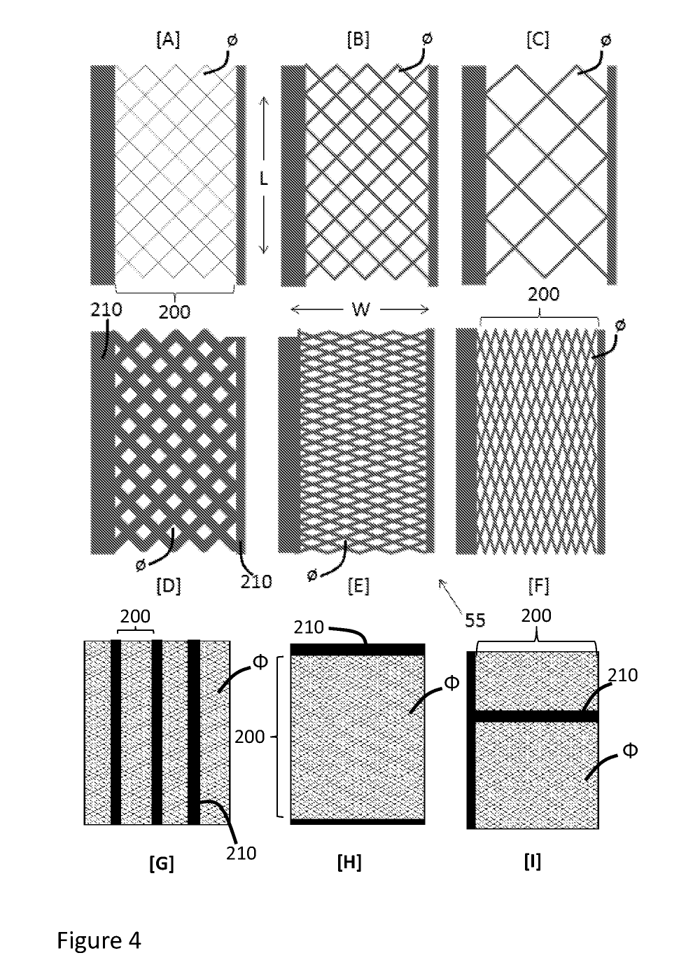

Referring now to FIG. 4 (A-I) various geometries associated with the lattice structure 200 in a fin section 55 are described. The specific geometry of the fin section 55 selected for use in the electrode case 3 is predetermined using operating criteria specific to each desired application, such as the temperature of the furnace, the amount of induced stress caused by the height, width, and resulting weight or load exhibited by the electrode, among others. Various design variables associated with the fin sections 55 can be altered in order to accommodate or meet the operating criteria. More specifically, these design variables include the width of fins, the thickness of fins, the percent open area of the fins, the width of the edge strips; and the angle () associated with the metal component in the lattice structure 200 to name a few. If the metal component in the lattice structure 200 is chosen to be too thin, the fin section 55 become flimsy and will fail under the load of the electrode, thereby, providing insufficient support for the electrode structure. If the metal component in the lattice structure 200 is chose to be too thick, the expansion of the metal under the high temperature of the furnace may cause the electrode to crack. FIG. 4 (A-D) provide specific examples demonstrating a change in amount of open area associated with the fin section 55. A comparison of the lattice structures shown in FIG. 4 (B, E, & F) demonstrates a change in the angle () associated with the metal component in the lattice structure 200.

The use of a lattice structure 200 over other geometries allows for greater open area within the structure through which the electrode can bake. The increased bake through area reduces the minimum baking height required to fully anchor the support structure in the electrode. It also reduces the tendency of the electrode to be consumed along the fin lines inside the furnace which results in an overall stronger electrode and lower consumption rates. The lattice structure 200 also provides a more even distribution of the average mechanical and thermal stresses imposed on the fin section 55 during baking and the transfer of the load from the carbon electrode to the electrode case 5. In each of FIG. 4(A-I) a constant volume of metal per unit length is demonstrated for each of the different lattice structures 200.

As shown in FIGS. 3 and 4 (A-I), the lattice structure 200 of the fin section 55 may optionally include a solid strip of metal or solid side bar 210 in at least the central region of each fin section. Alternatively, the side bars are included along the longitudinal edge of the upper interface region, the central support region, and the lower interface region. The side bars 210 may be used on both longitudinal edges of the fin section 55 as shown in FIG. 4(A-E), positioned along the interior of the lattice structure instead of at an edge as shown in FIG. 4F, along latitudinal edges as described in FIG. 4G or a combination of longitudinal and latitudinal positions as shown in FIG. 4I without exceeding the scope of the present disclosure. According to one aspect of the present disclosure, the solid side bar may be located along the entire length of the longitudinal edge of the fin section 55 as shown in FIG. 4(A-E). The side bars 210 may be either similar in width or one of the side bars can be wider than the other. The length and width of the side bars 210 may be predetermined based on the amount of structural support or integrity one skilled in the art desires the lattice structure 200 to provide. Optionally, the side bar 210 may also be located along the width (W) of the fin section 55.

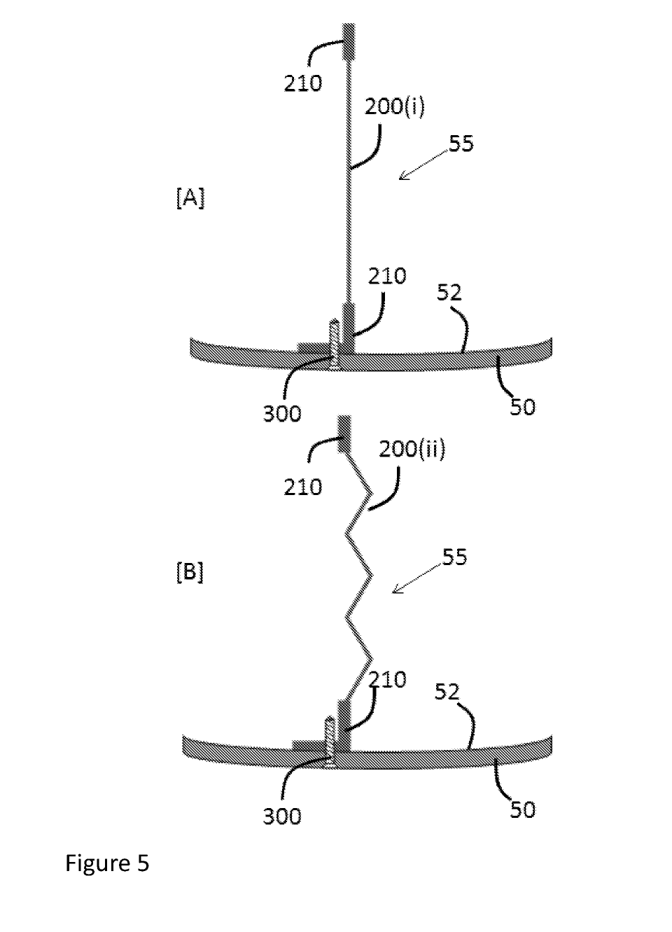

Referring now to FIG. 5 (A-B), one of the side bars is capable of contacting the inner surface 52 of the outer sleeve section 50 and can be used to fasten the fin section 55 thereto. The side bar 210 that makes contact with the inner surface 52 of the outer sleeve section 50 can be bent to be perpendicular with the fin section 55, thereby, allowing a portion of the side bar 210 to be flush with the inner surface 52 of the outer sleeve 50. This allows the fin section 55 to be fastened to the outer sleeve through the use of a fastener 300 as previously described. FIG. 5(A) demonstrates a fin section 55 in which the lattice structure 200(i) is linearly shaped along its width, while according to another aspect of the present disclosure the fin section 55 may also comprise a lattice structure 200(ii) that has a corrugated shape along its width as shown in FIG. 5(B). One skilled in the art will understand that the shape of the lattice structure 200 may also comprise another bent or non-linear geometry having any number of bends with each bend being of any radius, without exceeding the scope of the present disclosure.

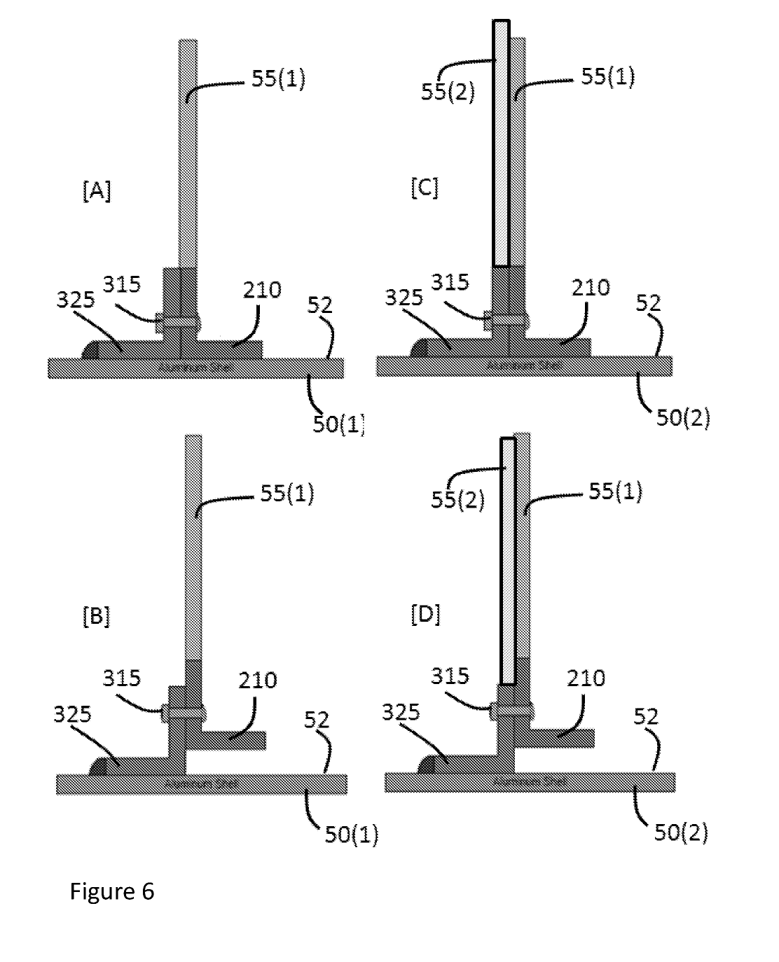

The bent side bar 210 may also optionally provide additional structural support and electrical continuity during the preparation of the electrode. Referring now to FIG. 6 (A-B), the bent side bar 210 may also be used to couple the lower interface region of one fin section 55(1) to a contact joint 325 secured to the inner surface 52 of the outer sleeve 50(1). As shown in FIG. 6A the fin section 55(1) overlaps with a contact joint 325, such that the fin section 55(1) is off-set from contact joint 325 and flush with the inner surface 52 of the outer sleeve 50. The alignment of one or more holes in the fin section 55(1) with the contact joint 325 through which a fastener 315, such as a bolt or rivet, among others, can be used to couple the two together. Physically fastening together the fin section 55(1) with the overlap joint 325 provides additional structural support and electrical continuity during the formation of the consumable electrode. In FIG. 6(B), the overlap of the fin section 55(1) is shown such that the lower section of the fin section 55(1) does not necessarily need to be flush with the inner surface 52 of the outer sleeve 50(1) in order to be coupled with the contact joint 325 using a fastener 315.

Referring now to FIG. 6 (C-D), the bent side bar 210 may also be used to couple the lower interface region of one fin section 55(1) to the upper interface region of another fin section 55(2) secured to the inner surface 52 of the outer sleeve 50(2). As shown in FIG. 6C the fin section 55(1) overlaps with the other fin section 55(2), such that the fin section 55(1) is off-set from the other fin section 55(2) and flush with the inner surface 52 of the outer sleeve 50(2). The alignment of one or more holes in the fin section 55(1) with the other fin section 55(2) through which a fastener 315, such as a bolt or rivet, among others, can be sued to couple the two together. Physically fastening together the fin sections 55(1, 2) at the overlap provides additional structural support and electrical continuity during the formation of the consumable electrode. In FIG. 6(D), the overlap of the fin sections 55(1, 2) is shown such that the lower section of the fin section 55(1) does not necessarily need to be flush with the inner surface 52 of the outer sleeve 50(2) in order to be coupled to the other fin section 55(2).

The electrode case of the present disclosure provides multiple benefits over conventional technology. The electrode case 5 of the present disclosure does not require the welding of the fin sections 55 to the outer sleeve sections 50, thereby, increasing productivity and reducing manufacturing costs. When stainless steel is used in the fin sections 55, the elimination of welding reduces potential worker exposure to the formation of hexavalent chromium compounds. The ability of the lattice structure 200 of the fin sections 55 to maintain a constant volume of metal per unit length allows the fin sections 55 to support a higher weight capacity and resist higher stresses induced by the electrode. The lattice structure 200 also allows for a substantial amount of open area in the fin section 55, thereby, allowing for an increase in the amount of bake through associated with the carbon paste 60 resulting in greater heat transfer, greater resistance to thermal stress, and a reduction in the formation of fault lines or crack propagation. Thus the lattice structure 200 allows for the number of fin sections 55 to be reduced, while maintaining sufficient structural support for the electrode being formed.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A self-baking electrode for use in an electric reduction furnace, the electrode comprising:
an outer sleeve; the outer sleeve being divided into multiple sleeve sections made from a first metal, such that each sleeve section has an outer and inner surface, the multiple sleeve sections capable of being stacked together to form the outer sleeve;
a plurality of fins; the fins being divided into multiple fin sections made from a second metal, such that each fin section is mechanically coupled to the inner surface of one sleeve section along its length; each fin section having an upper interface region, a central support region, and a lower interface region; the upper interface, central support, and lower interface regions having a lattice structure with at least 10% open area distributed such that each fin section exhibits a constant volume of the second metal per unit length, the upper interface region of one fin section being capable of overlapping with the bottom interface region of another fin section; and optionally, at least the central region of each fin section includes first and second side bars of a predetermined width and length; and
an electrode carbon paste; the paste being confined within the outer sleeve and in contact with the plurality of fins.

2. The electrode according to claim 1, wherein at least the central support region of each fin section comprises a lattice structure with greater than 30% open area.

3. The electrode according to claim 1, wherein the first metal in each sleeve section and the second metal in each fin section are independently selected as one from the group of aluminum, carbon steel, stainless steel, and copper.

4. (canceled)

5. (canceled)

6. The electrode according to claim 1, wherein the first side bar contacts the inner surface of the sleeve section and is fastened thereto.

7. The electrode according to claim 1, wherein the amount of overlap between the lower interface region of one fin section and the upper interface region of another fin section is predetermined to provide a degree of structural integrity to the electrode such that the fin sections do not need to be fastened together.

8. The electrode according to claim 1, wherein the lower interface region of one fin section and the upper interface region of another fin section are fastened together.

9. The electrode according to claim 1, wherein each fin section along its width is either straight or bent in shape and projects radially from the inner surface of the sleeve section.

10. The electrode according to claim 1, wherein at least one of the multiple sleeve sections is coupled to another sleeve section by either a weld or a slip joint.

11. An electrode case used to make a self-baking electrode that is consumed in a reducing arc furnace, the electrode case comprising:
an outer sleeve; the outer sleeve being divided into multiple sleeve sections made from a first metal, such that each sleeve section has an outer and inner surface, the multiple sleeve sections capable of being stacked together to form the outer sleeve; and
a plurality of fins; the fins being divided into multiple fin sections made from a second metal, such that each fin section is mechanically coupled to the inner surface of one sleeve section along its length; each fin section having an upper interface region, a central support region, and a lower interface region; the upper interface, central support, and lower interface regions having a lattice structure with at least 10% open area symmetrically positioned along the width such that each fin section exhibits a constant volume of the second metal per unit length, the upper interface region of one fin section being capable of overlapping with the bottom interface region of another fin section; and optionally, at least the central region of each fin section includes first and second side bars of a predetermined width and length.

12. The electrode case according to claim 11, wherein at least the central support region of each fin section comprises a lattice structure with greater than 30% open area.

13. (canceled)

14. (canceled)

15. The electrode case according to claim 11, wherein the first side bar contacts the inner surface of the sleeve section and is fastened thereto.

16. The electrode case according to claim 11, wherein the amount of overlap between the lower interface region of one fin section and the upper interface region of another fin section is predetermined to provide a degree of structural integrity to the electrode such that the fin sections do not need to be fastened together.

17. The electrode case according to claim 11, wherein the lower interface region of one fin section and the upper interface region of another fin section are fastened together.

18. The electrode case according to claim 11, wherein at least one of the multiple sleeve sections is coupled to another sleeve section by either a weld or a slip joint.

19. The electrode case according to claim 11, wherein the amount of open area in the plurality of fins is greater than or equal to 0.0042 cm² per vertical centimeter of case per kilogram of electrode to be supported.

20. An electrode case used to make a self-baking electrode that is consumed in a reducing arc furnace, the electrode case comprising:
an outer sleeve; the outer sleeve being divided into multiple sleeve sections made from a first metal, such that each sleeve section has an outer and inner surface, the multiple sleeve sections capable of being stacked together to form the outer sleeve; and
a plurality of fins, the fins being divided into multiple fin sections made from a second metal, such that each fin section is mechanically coupled to the inner surface of one sleeve section along its length; each fin section comprising a solid bar or cylinder having an upper interface region, a central support region, and a lower interface region such that each fin section exhibits a constant volume of the second metal per unit length, the upper interface region of one fin section being capable of overlapping with the bottom interface region of another fin section.

21. The electrode case according to claim 20, wherein the first metal in each sleeve section and the second metal in each fin section are independently selected as one from the group of aluminum, carbon steel, stainless steel, and copper.

22. A method comprising using the electrode case of claim 20 to make a self-baking electrode, wherein the method further comprises using the self-baking electrode in manufacturing of chemical grade silicon.

23. A method comprising using the self-baking electrode of claim 1 in manufacturing of chemical grade silicon.

24. A method comprising using the electrode case of claim 11 to make a self-baking electrode, wherein the method further comprises using the self-baking electrode in manufacturing of chemical grade silicon.
